(19) United States
(12) Patent Application Publication
(10) Pub. No.: US 2022/0275871 A1
(43) Pub. Date: Sep. 1, 2022

(54) DIAPHRAGM VALVE

(71) Applicant: FUJIKIN INCORPORATED, Osaka-shi (JP)

(72) Inventors: Keisuke Ishibashi, Osaka-shi (JP); Toshihide Yoshida, Osaka-shi (JP); Tadayuki Yakushijin, Osaka-shi (JP); Michio Yamaji, Osaka-shi (JP); Tsutomu Shinohara, Osaka-shi (JP)

(73) Assignee: FUJIKIN INCORPORATED, Osaka-shi (JP)

(21) Appl. No.: 17/622,756

(22) PCT Filed: Jun. 8, 2020
(86) PCT No.: PCT/JP2020/022461

§ 371 Date: Dec. 24, 2021

(30) Foreign Application Priority Data
Jun. 27, 2019 (JP) 2019-119519

(51) Int. Cl. F16K 7/17; F16K 31/122

(52) U.S. Cl. CPC F16K 7/17; F16K 31/1221; F16K 39/02

(57) ABSTRACT

To provide a control valve with excellent durability performance without being restricted in terms of applications, such as usages under high pressures or high temperatures, as well as reduced generation of particles. A valve body forming an inflow passage and an outflow passage of a fluid; a valve seat formed at a peripheral edge of the inflow passage in the valve body; a diaphragm configured to connect and shut off the inflow passage and the outflow passage by coming into and out of contact with the valve seat; a diaphragm holder configured to press a central portion of the diaphragm; and an actuator configured to move the diaphragm holder are provided, includes a regulation mechanism configured to adjust a closing pressure generated between the valve seat and the diaphragm to a predetermined pressure.

### TECHNICAL FIELD

The present invention relates to a control valve for a fluid, and to a diaphragm valve which can be suitably used as a shutoff valve configured to open and close for high pressure or high temperature fluids.

### BACKGROUND ART

A control valve capable of regulating a flow rate of a fluid and opening and closing is known to be provided with a valve body having a fluid flow path, a diaphragm configured to open and close the flow path by coming into and out of contact with a valve seat, and an actuator configured to move a diaphragm holder configured to press the diaphragm up and down (Patent Literature 1).

### CITATION LIST

### Patent Literature

[Patent Document 1] Reissue of JP-T-2015/020209

### SUMMARY OF INVENTION

### Technical Problem

In the above control valve, an operating pressure is applied by supplying operation air to the built-in actuator. Since a thrust (pressing force) repeatedly acts on a space between the valve seat and the diaphragm (sealed part) as the flow path is opened and closed, durability of the seal is important.

For example, the control valve configured to open and close for a high-pressure fluid generally has a metal seal structure in which a valve seat formed on a valve body and a diaphragm configured to contact with the valve seat are both made of metal. If the valve seat or valve element is scratched, not only will the life of the valve be shortened, but also minute particles of these materials will be generated from abutting surfaces of the valve seat and the diaphragm, which will be mixed into a fluid to be processed passing through the valve, thereby causing contamination of the fluid to be processed.

It is an object of the present invention to provide a control valve with excellent durability performance without being restricted in terms of applications, such as usages under high pressures or high temperatures, as well as reduced generation of particles.

### Solution to Problem

The invention (1) provides a diaphragm valve comprising:

a valve body forming an inflow passage and an outflow passage of a fluid;
a valve seat formed at a peripheral edge of the inflow passage in the valve element;
a diaphragm configured to connect and shut off the inflow passage and the outflow passage by coming into and out of contact with the valve seat;
a diaphragm holder configured to press a central portion of the diaphragm; and
an actuator configured to move the diaphragm holder,
in which the diaphragm valve comprises a regulation mechanism configured to regulate a closing pressure generated between the valve seat and the diaphragm to a predetermined pressure.

In the control valve of the related art, a thrust acting between the diaphragm and the valve seat when the flow path is closed is set to a value which is high enough to close the flow path completely (maximum value) even when the pressure on an inflow passage side and the pressure on an outflow passage side changes, so that the maximum thrust constantly acts regardless of changes in pressure on the inflow passage side and on the outflow passage side.

In contrast, in the diaphragm valve of the present invention, the thrust (to close the valve) acting between the diaphragm and the valve seat when the flow path is closed is adjusted to a value suitable for completely closing the flow path in response to changes in pressure on the inflow passage side. The closing pressure refers to a pressure that the diaphragm can apply to stop the flow of the fluid. When an excessing closing pressure is applied abutment surfaces of the diaphragm and the valve seat, minute scratches may be made on the abutment surfaces, which may result in decrease in the life of the valve. Since minute particles may be generated from the abutment surfaces, if such minute particles are mixed into the fluid to be processed, which passes through the valve, the fluid to be processed may be contaminated.

When adjusting the thrust to a suitable value, the closing pressure between the valve seat and the diaphragm is controlled to a suitable pressure with the shape of the flow path (a direction in which the pressure on the inflow passage side acts) as well as whether the valve is normally-open type or normally-close type in consideration.

The invention (2) provides the diaphragm valve according to the invention (1), wherein the predetermined pressure is in a range from 105 to 140% of the pressure on an upstream side of the diaphragm when the diaphragm is in abutment with the valve seat.

The inventors of the present invention repeated a number of times of experiments and found that in the valve having a metal diaphragm and a metal valve seat, amounts of scratches generated on the abutment surfaces of the diaphragm and the valve seat and the particles generated by repeated opening and closing of the valve are related to the closing pressure of the valve. This founding let to the present invention.

It was found that application of a biasing (closing) pressure in a range from 105 to 140% of the fluid pressure on the upstream side of the diaphragm when the diaphragm is in abutment with the valve seat may extremely reduce the amount of the scratches generated on the abutment surfaces of the diaphragm and the valve seat and particles generated by the repeated opening and closing of the valve. The range is preferably from 105 to 135%, and more preferably, from 105 to 125%.

When subtracting the pressure from the fluid to be processed that may contact with a concave surface of the diaphragm from the lower limit value 105%, a pressure corresponding to 5% of the pressure of the fluid to be processed is applied to the abutment surfaces of the diaphragm and the valve seat, and the pressure may support the valve in the closed state. When subtracting the pressure from the fluid to be processed that may contact with a concave surface of the diaphragm from the upper limit value 140%, a pressure corresponding to 40% of the pressure of the fluid to be processed is applied to the abutment surfaces of the diaphragm and the valve seat. The pressure in this range can suppress the generation of the scratches and the particles to an extremely low level. The smaller the upper limit value is in this range, the more desirable it is.

The present invention (3) is a diaphragm valve according to the invention (1) or (2), in which the diaphragm valve is of the normally-close type that is normally closed, and the actuator includes a piston connected to the diaphragm holder, a spring configured to bias the piston in a direction of closing the valve, and a fluid pressurization mechanism configured to bias the piston in a direction of opening the valve, and in which the regulation mechanism is a movable member that regulates an amount of deflection of the spring.

The normally closed normally-close type diaphragm valve is configured to assume a fully closed state, which is a state of being biased by a biasing member such as a spring, and the maximum pressure acts between the diaphragm and the valve seat. In the diaphragm valve of the related art, the closing pressure acting between the diaphragm and the valve seat is not regulated. In the control valve of the invention, the closing pressure acting between the diaphragm and the valve seat can be regulated by a regulation mechanism.

In the normally-close type diaphragm valve, the diaphragm holder is moved by the spring, and thus the adjustment is achieved with the movable member configured to adjust the amount of deflection of the spring. The pressure of the fluid flowing through the valve varies depending on the intended use of the valve and may vary from day to day even with the same valve installed. In this case, if the pressure of the fluid flowing through the valve is low, the amount of deflection of the spring is set to be smaller, and if the pressure of the fluid flowing through the valve is high, the amount of deflection of the spring is set to be large, so that adjustment of the closing pressure of the diaphragm valve is enabled.

The present invention (4) is a diaphragm valve according to the invention (1) or (2), in which the normally-open type diaphragm valve, which is normally open, and the actuator includes a piston connected to the diaphragm holder, a fluid pressurization mechanism configured to bias the piston in the direction of closing the valve, and a spring configured to bias the piston in the direction of opening the valve, and in which the regulation mechanism is a pressure control valve provided in the middle of the fluid path of the fluid pressurization mechanism for adjusting the fluid pressure.

The normally-open type diaphragm valve, which is normally opened, is configured to assume a fully closed state, which is a state having the maximum operating pressure applied by the fluid pressurization mechanism, and the maximum pressure acts between the diaphragm and the valve seat. In the diaphragm valve of the related art, the closing pressure acting between the diaphragm and the valve seat is not regulated. In the control valve of the invention, the closing pressure acting between the diaphragm and the valve seat can be regulated by a regulation mechanism.

In a normally-open type diaphragm valve, the diaphragm holder is moved by a piston in the actuator, which is moved by a fluid pressurization mechanism that biases the direction of closing the valve. The fluid pressurization mechanism applies pressure to the piston by flowing operation air or the like to drive the piston. By adjusting the pressure of the fluid flowing to the fluid pressurization mechanism, the closing pressure can be adjusted.

The pressure of the fluid flowing through the valve varies depending on the intended use of the valve and may vary from day to day even with the same valve installed. In this case, if the pressure of the fluid to be processed flowing through the valve is low, the pressure of flow toward the fluid pressurization mechanism is set to be smaller, and if the pressure of the fluid to be processed flowing through the valve is high, the pressure of the fluid to be flowed toward the fluid pressurization mechanism is set to be large, so that adjustment of the closing pressure of the diaphragm valve is enabled.

### Advantageous Effect

According to the diaphragm valve of the present invention, the durability of the diaphragm and the valve seat is improved because the closing pressure acting between the valve element and the valve seat is adjusted to a suitable value when the flow path is closed. In addition, since the generation of minute particles from the abutment surfaces of the diaphragm and the valve seat can be suppressed, so that contamination of the fluid to be processed flowing through the valve can be reduced.

### BRIEF DESCRIPTION OF DRAWINGS

FIG. 1 illustrates a normally-close type diaphragm valve in a fully closed state.

FIG. 2 illustrates the normally-close type diaphragm valve in a fully opened state.

FIG. 3 illustrates a normally-open type diaphragm valve in a fully opened state.

FIG. 4 illustrates the normally-open type diaphragm valve in a fully closed state.

FIG. 5 illustrates a relationship between the number of particles generated per one opening-closing operation and a sealing pressure/charged pressure (%) of the normally-close type diaphragm valve.

### DESCRIPTION OF EMBODIMENTS

Embodiments of the invention will be described below with reference to the drawings. In the following description, expressions upper and lower correspond to upper and lower of the drawings. The expressions “upper and lower” are used for the sake of convenience, and the apparatus may be installed upside down or horizontally depending on circumstances.

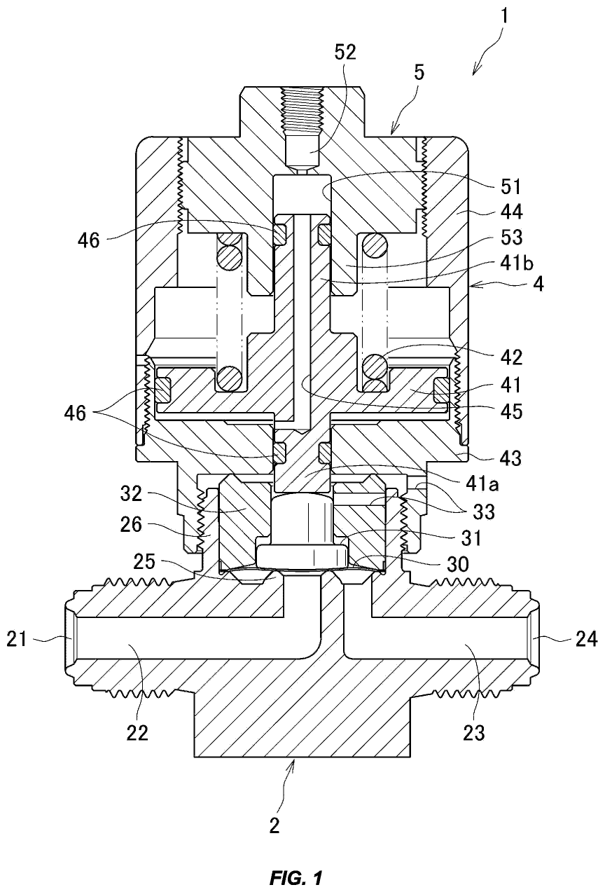

As illustrated from FIG. 1 to FIG. 4, a diaphragm valve 1 includes: a valve body 2 having a fluid passage; a diaphragm 30 configured to open and close the flow path in the valve body 2; and an actuator 4 configured to drive a diaphragm holder 31 configured to press the diaphragm 30 upward and downward.

The valve body 1 includes an inflow port 21 from which a fluid enters, an inflow passage 22, which corresponds to the fluid path, an outflow passage 23, and an outflow port 24 through which the fluid exits, formed in an interior thereof. A bonnet 26 projecting upward and including a depressed part formed inside thereof is provided on an upper part of the valve body 1, and a valve seat 25 configured to come into and out of contact with a diaphragm 30 is formed at an upper opening peripheral edge of the inflow passage 22.

The diaphragm 30 is pressed from above and secured to a bottom of the depressed part inside the bonnet 26 by a holding adapter 32. An upper shaft portion of the diaphragm holder 31 is inserted into a center of the holding adapter 32, and an air-bleeding hole 33 for air bleeding is formed in the holding adapter 32 in a horizontal direction .

The actuator 4 includes two casings; an upper casing 44 and a lower casing 43, and the lower casing 43 includes a projection projecting downward. The projection includes a depressed part opening downward. The depressed part accommodates the holding adapter 32, and a male thread formed on an outer periphery of the bonnet 26 engages a female thread formed on an inner wall of the depressed part of the lower casing 43. A lower part of the lower casing 43 also includes the air-bleeding hole 33 for bleeding air.

The upper casing 44 has a substantially cylindrical shape, and the lower casing 43 includes a depressed part on an upper part thereof. A male thread formed on an outer wall of the upper depressed part of the lower casing 43 engages a female thread formed on an inner wall of the lower part of the upper casing 44. The actuator 4 is provided with a piston 41 in the interior thereof, and on a bottom surface of the piston 41, a piston bottom projection 41a configured to press a head part of the diaphragm holder 31 is formed. The piston bottom projection 41a is inserted into a through hole formed at a center of the lower casing 43.

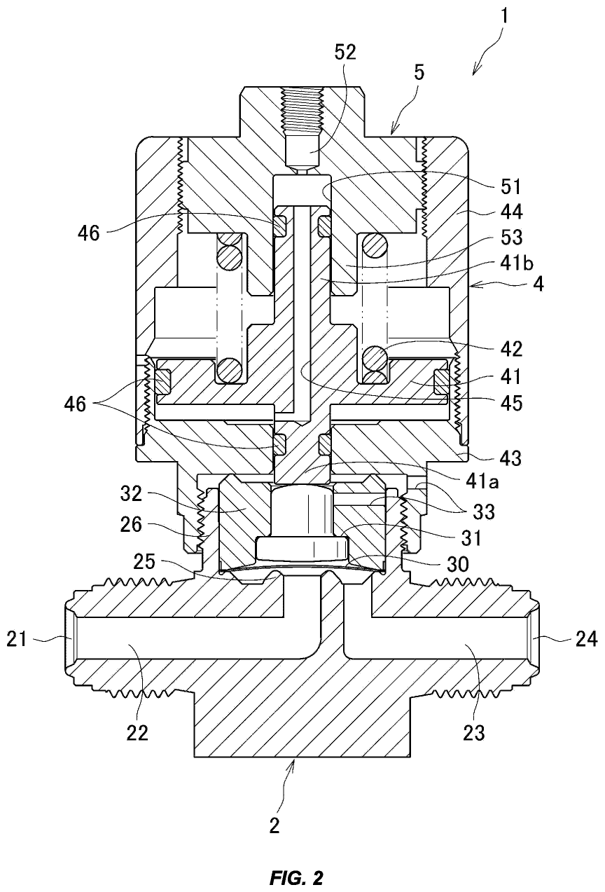

FIG. 1 illustrates a normally-close type diaphragm valve 1 in a fully closed state, and FIG. 2 illustrates a normally-close type diaphragm valve 1 in a fully opened state. A female thread formed on an inner surface of the upper portion on the upper casing 44, and with the female thread, a movable member 5, which is a regulation mechanism having a male thread formed on an outer periphery thereof to be engaged with the female thread, engages. The movable member 5 includes a movable member lower projection 53 projecting downward from a lower surface of a lower part thereof, and a movable member depressed part 51, which is a depressed part into which a piston upper projection 41b projecting from an upper surface of the piston 41 fits. The piston 41 includes an O-ring 46 for maintaining hermeticity.

The movable member 5 includes an operation air inlet port 52 configured to introduce air, for example, which is an operation fluid for driving the piston 41, at an upper portion. The operation air passes through an operation air passage 45 formed in the interior of the piston 41 and introduced to a lower surface side of the piston 41 to move the piston 41 upward.

The piston 41 includes an annular groove for accommodating a lower end of the spring 42 on an upper surface thereof. The upper side of the spring 42 is in abutment with the lower surface of the movable member 5 to accommodate the movable member 5 lower projection 53. The spring 42 is disposed between the piston 41 and the movable member 5 and works to move the piston 41 downward from above.

A high-pressure fluid flows in the inflow passage 22 and the outflow passage 23. Since the high-pressure fluid is present at an opening of the inflow passage 22 on the diaphragm 30 side, a pressure generated by the high-pressure fluid to push upward is applied to the lower surface of the diaphragm 30. The position of the movable member 5 is adjusted by the extent of the pressure of the high-pressure fluid, and the amount of deflection of the spring 42 is adjusted. A method of adjusting is configured such that a downward pressing force of the spring 42 is adjusted so that a closing pressure of 105 to 140% of the pressure of the high-pressure fluid is exerted to the upper surface of the diaphragm 30. Specifically, the amount of deflection of the spring 42 is adjusted such that the pressing force corresponding to a product of the surface area of a circle within a range supported by the valve seat 25 and a pressure of 105 to 140% of the pressure of the high-pressure fluid appears.

In this manner, depending on the degree of the pressure of the high-pressure fluid flowing in the diaphragm valve 1, the closing pressure applied to the abutment surfaces of the valve seat 21 and the diaphragm 30 is reduced to suppress the generation of scratches and the generation of particles on the abutment surfaces.

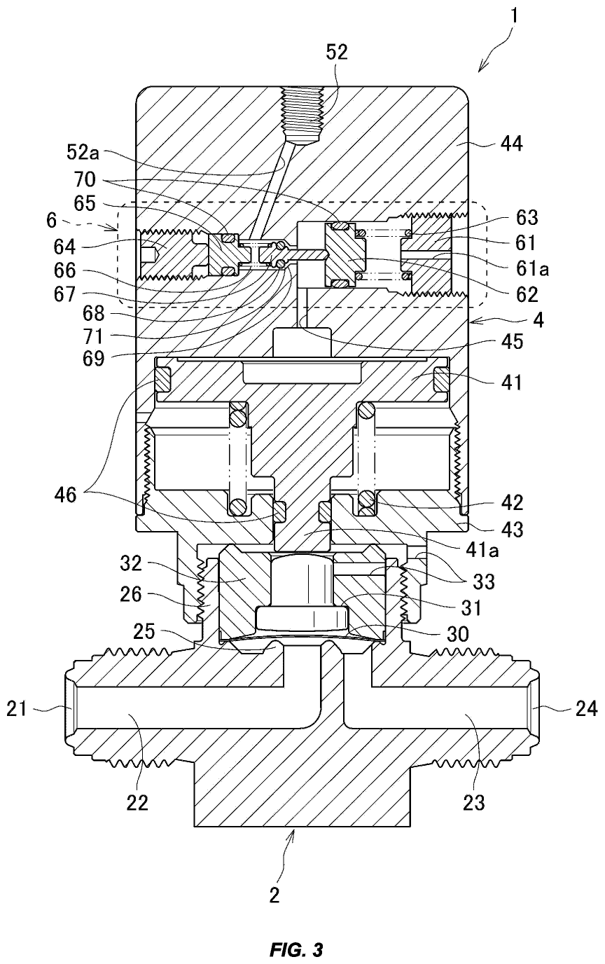

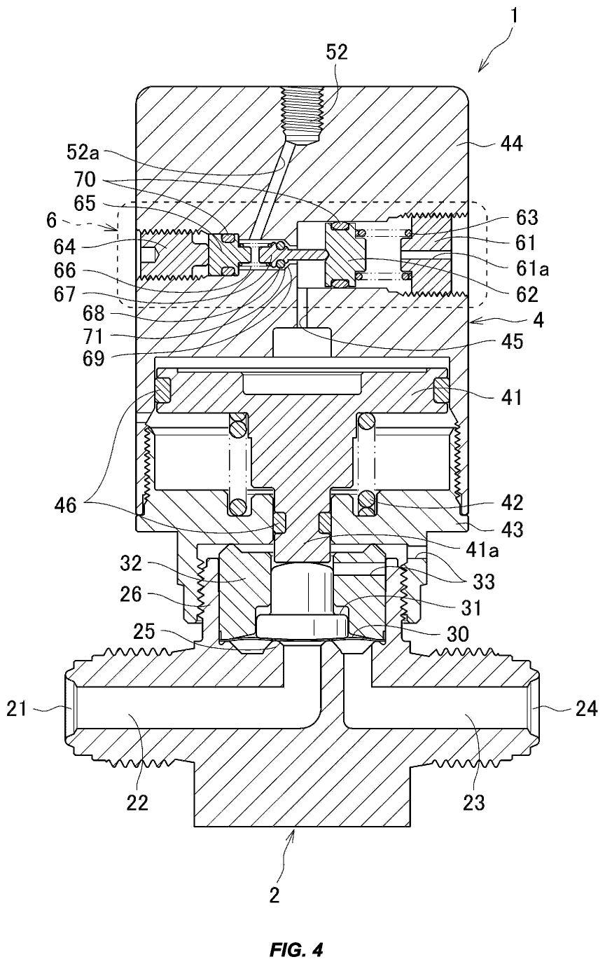

FIG. 3 and FIG. 4 illustrates the normally-open type diaphragm valve 1, in which FIG. 3 illustrates a fully opened state and FIG. 4 illustrates a fully closed state. The regulation mechanism is composed of a flow regulation valve 6, unlike FIG. 1 and FIG. 2. The spring 42 provided on an upper surface side of the lower casing 43 and the lower surface side of the piston 41 acts to push the piston 41 upward. To keep air-tightness in the interior of the actuator 4, the piston 41 is provided with an O-ring 46.

The operation air introduced through the operation air inlet 52 passes through an operation air passage 52a and enters the regulation mechanism (pressure control valve) 6 surrounded by a dotted line. The pressure control valve 6 is a so-called air regulator and is not specifically limited if it has a configuration of the air regulator. However, the configuration of the embodiment includes, from the right side, an adjustable screw 61 having a male thread formed on an outer periphery and an air-bleeding hole 61a, a pressure control valve first spring 63, a regulating piston 62, a pressure control valve seat 69, a pressure control valve element 67 having a pressure control valve element abutting part 68, a pressure control valve second spring 66, a fixing member 65, and a sealing plug 64, and an O-ring 70 for maintaining air-tightness in the interior is provided.

When the adjustable screw 61 is rotated and moved toward the regulating piston 62, the regulating piston 62 is pressed to be moved leftward by a biasing force of the pressure control valve first spring 63. When the regulating piston 62 is moved leftward, the pressure control valve element 67 moves leftward to increase a gap 71 between the pressure control valve element abutting part 68 and the valve seat 69 of the pressure control valve 6. When the gap 71 is increased, easy passage of the operation air is achieved, and thus the fluid pressure increases, so that the pressure applied on the piston 41 increases. In contrast, when the adjustable screw 61 is rotated to move away from the regulating piston 62, the amount of deflection of the pressure control valve first spring 63 decreases, and thus the pressure control valve element 67 is moved rightward by a rightward biasing force of the pressure control valve first spring 66, thereby narrowing the gap 71. When the gap 71 is narrowed, the passage of the operation air becomes difficult, and thus the fluid pressure decreases, so that the pressure applied on the piston 41 decreases. The operation air flows from the pressure control valve 6 through the operation air passage 45 and presses the upper surface of the piston 45.

Like the normally-close type diaphragm valve (FIG. 1 and FIG. 2), a high-pressure fluid flows in the inflow passage 22 and the outflow passage 23. Since the high-pressure fluid is present at an opening of the inflow passage 22 on the diaphragm 30 side, a pressure generated by the high-pressure fluid to push upward is applied to the lower surface of the diaphragm 30. Depending on the degree of the pressure of the high-pressure fluid, the position of the adjustable screw 61 is adjusted to adjust the size of the gap 71. A method of adjusting is configured such that a downward pressing force of the operation air is adjusted so that a closing pressure of 105 to 140% of the pressure of the high-pressure fluid is exerted to the upper surface of the diaphragm 30. Specifically, the size of the gap 71 is adjusted such that the pressing force corresponding to a product of the surface area of a circle within a range supported by the valve seat 25 and a pressure of 105 to 140% of the pressure of the high-pressure fluid applies to the diaphragm 30.

Actually, the normally close type diaphragm valve was fabricated, a test for measuring the number of generated minute particles by opening and closing the valve while changing the pressure of the high-pressure fluid and the closing pressure applied to the diaphragm.

The number of generated minute particles was counted by CPC method. The CPC method is a method of counting the number of particles by using a technique called nuclear condensation, which enables detection of minute particles in a nano-region, which cannot be counted by a particle counter using an ordinary laser method, by enlarging the diameter of the particles. All particles having diameters ranging from 0.004 μm to 3.0 μm are targets.

A measurement instrument used here was MODEL 3775 from TSI Holdings Inc. This measurement instrument is an alcohol condensate type particle counter. The experiment was conducted with a suction volume in an inner pipe of double piping of 0.3 L/min, a particle count suction volume of 0.01 cf/min (0.3 L/min), a data sampling interval of every 2 seconds, a test piece being opened for 1 second and closed for 1 second, a test duration of 10 minutes (300 openings and closings), a flowed fluid of nitrogen gas, a flow rate of 0.1 L/min, and a temperature of the test piece of 25° C.

The measurement results are shown in Table 1 below. Here, the charged pressure is the pressure of the fluid flowing into the inflow passage 22 of the diaphragm valve 1, and the sealing pressure is the pressure that presses the diaphragm 30.

TABLE 1

| | | | | | NUMBER OF |
|---|---|---|---|---|---|
| | | NUMBER OF | | SEALING | PARTICLES |
| | | OPENING AND | | PRESSURE/ | GENERATED |
| CHARGED | | CLOSING | SEALING | CHARGED | PER ONE |
| PRESSURE | SAMPLE | (UNIT: TEN | PRESSURE | PRESSURE | OPENING/ONE |
| (MPa) | NO. | THOUSANDS) | (MPa) | (%) | CLOSING |
| 16 | 5 | 30 | 23.8 | 149 | 0.360 |
| 16 | 2 | 10 | 21.9 | 137 | 0.007 |
| 16 | 2 | 30 | 21.0 | 131 | 0.000 |
| 16 | 2 | 50 | 20.2 | 126 | 0.007 |
| 16 | 2 | 70 | 19.3 | 121 | 0.003 |
| 16 | 2 | 85 | 18.7 | 117 | 0.013 |
| 16 | 3 | 10 | 21.9 | 137 | 0.007 |
| 16 | 4 | 10 | 21.9 | 137 | 0.000 |
| 16 | 1 | 10 | 21.1 | 132 | 0.000 |
| 16 | 1 | 30 | 20.2 | 126 | 0.073 |
| 15 | 5 | 30 | 23.5 | 157 | 0.493 |
| 15 | 5 | 70 | 21.5 | 143 | 0.560 |
| 21 | 5 | 10 | 24.5 | 117 | 0.000 |
| 21 | 5 | 30 | 23.5 | 112 | 0.000 |

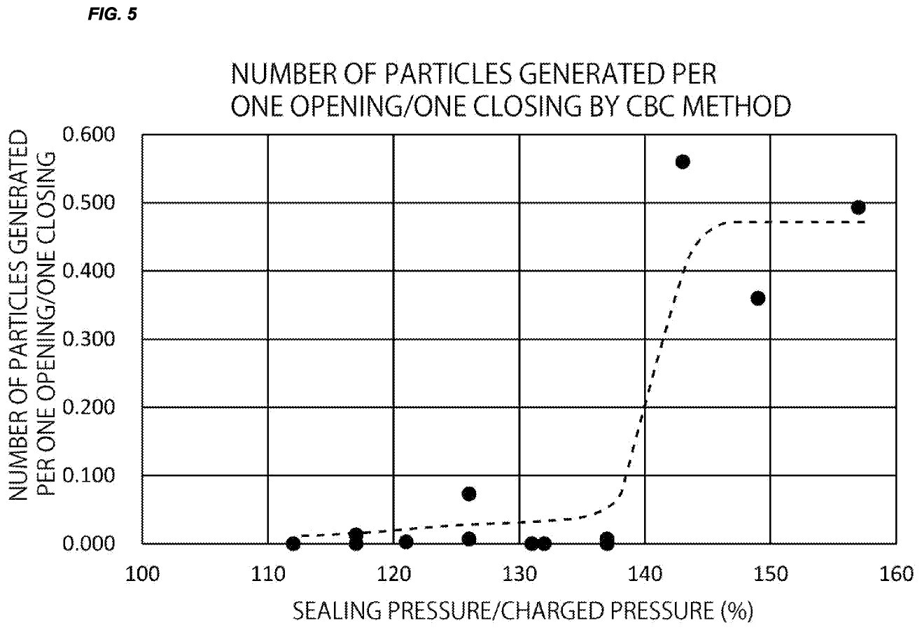

FIG. 5 is a graph showing the values in Table 1. As is understood from FIG. 5, the number of generated particles significantly increases when the sealing pressure/charged pressure (%) exceeds a boundary at 140%, and the number of generated particles is significantly reduced when the number of particles is equal to or smaller than 140%.

### INDUSTRIAL APPLICABILITY

The diaphragm valve according to the present invention achieves a suitably long-life usage as a shutoff valve configured to open and close for high-pressure or high-temperature fluids, and thus can reduce generation of particles due to the opening and closing operation of the valve.

### REFERENCE SIGNS LIST

1: diaphragm valve
2: valve body
4: actuator
5: movable member (regulation mechanism)
6: pressure control valve (regulation mechanism)
21: inlet port
22: inflow passage
23: outflow passage
24: outlet port
25: valve seat
26: bonnet
30: diaphragm
31: diaphragm holder
32: holding adapter
41: piston
41a: piston lower projection
41b: piston upper projection
42: spring
43: lower casing
44: upper casing
45: operation air passage
46: O-ring
51: movable member depressed part
52: operation air inlet
52a: operation air passage
53: movable member lower projection
61: adjustable screw
61a: air-bleeding hole
62: regulating piston
63: pressure control valve first spring
64: sealing plug
65: fixing member
66: pressure control valve second spring
67: pressure control valve element
68: pressure control valve element abutting part
69: pressure control valve seat
70: O-ring
71: gap

1. A diaphragm valve comprising:
a valve body forming an inflow passage and an outflow passage of a fluid;
a valve seat formed at a peripheral edge of the inflow passage in the valve body;
a diaphragm configured to connect and shut off the inflow passage and the outflow passage by coming into and out of contact with the valve seat;
a diaphragm holder configured to press a central portion of the diaphragm; and
an actuator configured to move the diaphragm holder,
wherein the diaphragm valve comprises a regulation mechanism configured to adjust a closing pressure generated between the valve seat and the diaphragm to a predetermined pressure.

2. The diaphragm valve according to claim 1, wherein the predetermined pressure is in a range from 105 to 140% of a pressure on an upstream side of the diaphragm when the diaphragm is in abutment with the valve seat.

3. The diaphragm valve according to claim 1, wherein the diaphragm valve is of the normally-close type that is normally closed, and the actuator includes a piston connected to the diaphragm holder, a spring configured to bias the piston in a direction of closing the valve, and a fluid pressurization mechanism configured to bias the piston in a direction of opening the valve, and the regulation mechanism is a movable member that regulates an amount of deflection of the spring.

4. The diaphragm valve according to claim 1, wherein the normally-open type diaphragm valve, which is normally open, and the actuator includes a piston connected to the diaphragm holder, the fluid pressurization mechanism configured to bias the piston in the direction of closing the valve, and a spring configured to bias the piston in the opening direction of the valve, and the regulation mechanism is a pressure control valve provided in a middle of the fluid path of the fluid pressurization mechanism for adjusting the fluid pressure.

5. The diaphragm valve according to claim 2, wherein the diaphragm valve is of the normally-close type that is normally closed, and the actuator includes a piston connected to the diaphragm holder, a spring configured to bias the piston in a direction of closing the valve, and a fluid pressurization mechanism configured to bias the piston in a direction of opening the valve, and the regulation mechanism is a movable member that regulates an amount of deflection of the spring.

6. The diaphragm valve according to claim 2, wherein the normally-open type diaphragm valve, which is normally open, and the actuator includes a piston connected to the diaphragm holder, the fluid pressurization mechanism configured to bias the piston in the direction of closing the valve, and a spring configured to bias the piston in the opening direction of the valve, and the regulation mechanism is a pressure control valve provided in a middle of the fluid path of the fluid pressurization mechanism for adjusting the fluid pressure.
